(19) United States
(12) Patent Application Publication
(10) Pub. No.: US 2016/0061230 A1
(43) Pub. Date: Mar. 3, 2016

(54) HYDRAULIC SWIVEL ASSEMBLY

(71) Applicant: GENESIS ATTACHMENTS, LLC, Superior, WI (US)

(72) Inventors: Daniel P. Jacobson, Wrenshall, MN (US); Chad Wood, Duluth, MN (US); Daniel J. Raihala, Superior, WI (US); Steven T. Letko, Hermantown, MN (US)

(21) Appl. No.: 14/783,564

(22) PCT Filed: Apr. 9, 2013
(86) PCT No.: PCT/US13/35819

§ 371 Date: Oct. 9, 2015

(51) Int. Cl. F15B 13/08; F15B 15/08; E02F 9/00; F15B 11/16

(52) U.S. Cl. CPC F15B 13/0807; F15B 11/16; F15B 15/08; E02F 9/006

(57) ABSTRACT

A hydraulic swivel assembly includes a hydraulic swivel having a plurality of ports on a base and a plurality of ports on a rotatable extension. A manifold block is secured to the base, and has a corresponding plurality of ports matingly aligning with the plurality of ports of the base, whereby the plurality of ports of the manifold block are adapted to couple to a first set of hydraulic lines from a non-rotating member and the plurality of ports on the rotatable extension are adapted to couple to a second set of hydraulic lines which rotate with the rotatable member.

### BACKGROUND

Hydraulic swivels are used to communicating hydraulic fluid between a non-rotatable member and a rotatable member. Hydraulic swivels are commonly used in material handling attachments, such as demolition shear attachments, concrete crusher attachments, grapple attachments, and the like, which are adapted to attach to the boom or stick of an excavator. A swivel attachment is often mounted to the rearward end of the material handling attachment and is pinned to the boom or stick of the excavator to permit more manipulation of the material handling attachment such that it can be both pivoted with respect to the excavator boom as well as longitudinally rotated for positioning the hydraulically actuated jaws, or other elements at the forward end of the material handling attachment, over the work piece to be sheared, crushed, lifted, gathered or otherwise processed.

Currently, hydraulic swivel assemblies for material handling attachments are very labor intensive to install because of the number of parts or components utilized. Due to these number of parts, there are more parts that require maintenance or repair and there are many potential leak points that may requiring maintenance or repair. Accordingly, there is a need for an improved hydraulic swivel assembly which minimizes the number of components to reduce manufacturing, installation, maintenance and repair costs, and which minimizes the number of potential leak points that may require repair and maintenance.

### DESCRIPTION OF THE DRAWINGS

FIG. 1 is a perspective view of an embodiment of a demolition shear attachment with an embodiment of a swivel attachment mounted to the rearward end of the main body of the shear attachment.

FIG. 2 shows the shear attachment and swivel attachment of FIG. 1 mounted to the boom of an excavator.

FIG. 3 is an enlarged view of a portion of the swivel attachment of FIG. 1.

FIG. 4 is a partial cut-away, front perspective view of the swivel attachment of FIG. 1 showing an embodiment of an improved hydraulic swivel assembly.

FIG. 5 is a partial cut-away, rear perspective view of the swivel attachment of FIG. 1 showing the embodiment of the improved hydraulic swivel assembly of FIG. 4 from the rear.

FIG. 6 is a partial cross-sectional view of an embodiment of the manifold for the improved hydraulic swivel assembly.

FIG. 7 is an exploded perspective view of a prior art hydraulic swivel assembly.

### DESCRIPTION

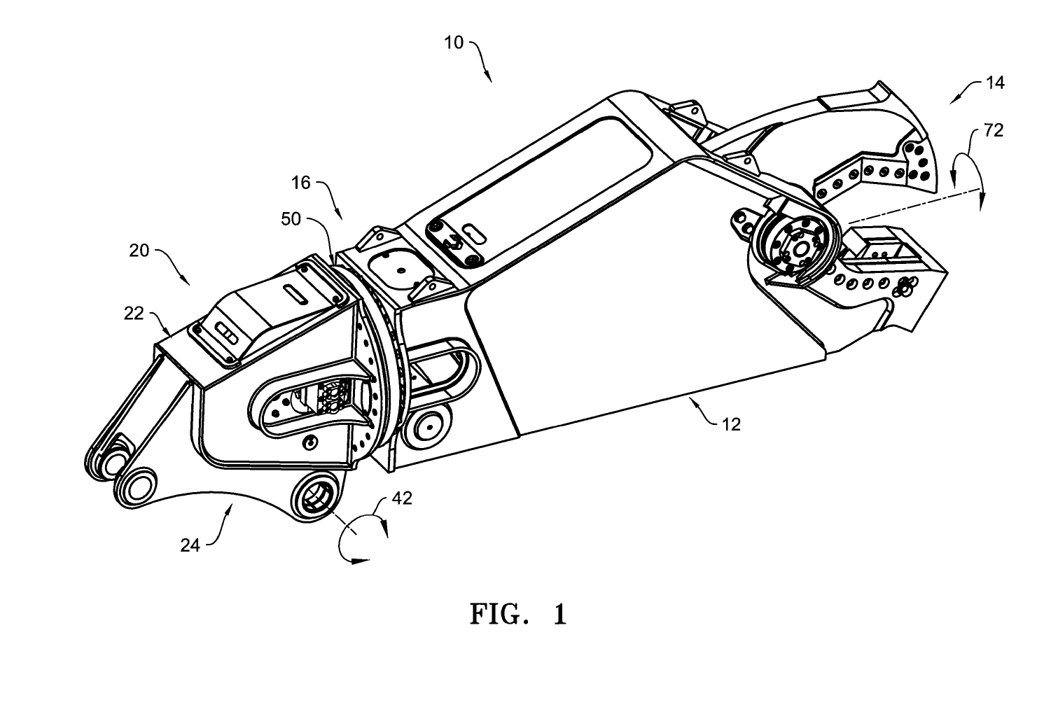

Referring to the drawings wherein like reference numerals designate the same or corresponding parts throughout the several views, FIG. 1 is a perspective view of an embodiment of a material handling attachment 10 having a main body 12 with a forward end 14 and a rearward end 16. The forward end 14 of the main body 12 operably supports material handling jaws or other material handling elements.

Although a demolition shear attachment is illustrated in the drawing figures and is referenced in this specification, it should be understood that the term “material handling attachment” as used herein and in the claims, refers to and includes any type of material handling attachment, including, but not limited to, demolition shear attachments, concrete crusher attachments, grapple attachments, and the like.

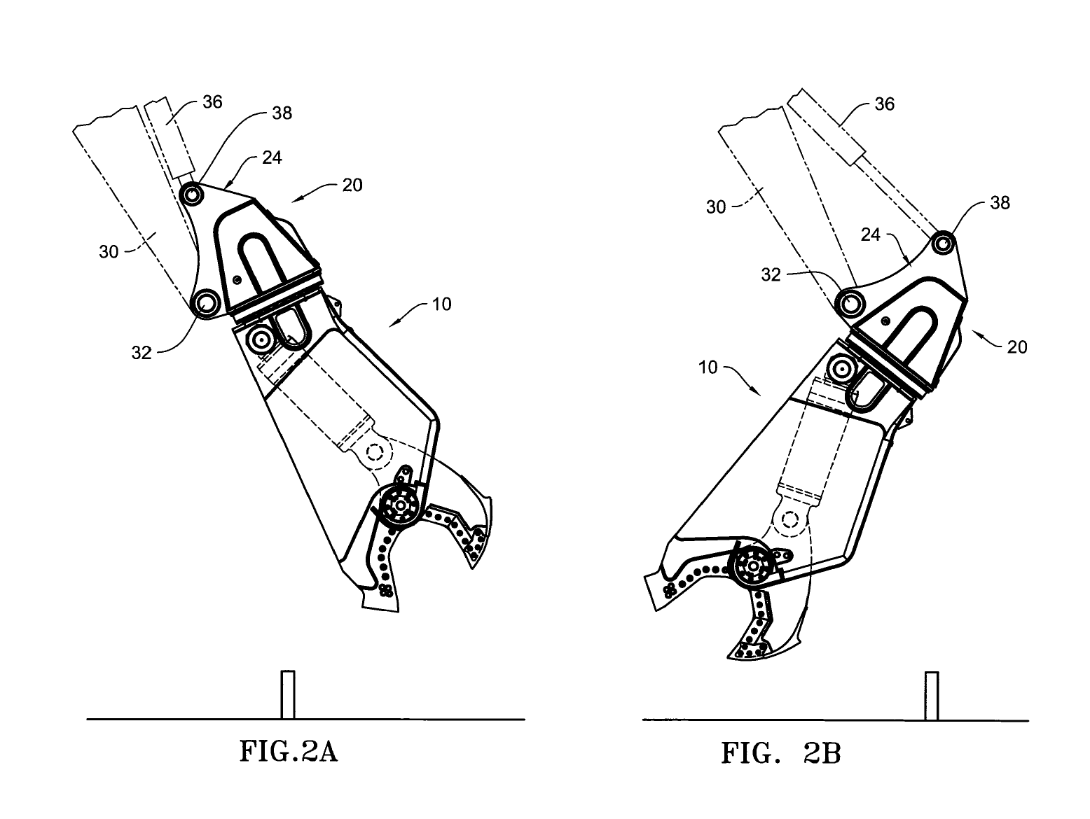

A swivel attachment 20 is shown mounted to the rearward end 16 of the main body 12. The swivel attachment 20 includes a swivel house 22 which supports a boom mount bracket 24 at its lower rearward end and a gear tooth bearing or slewing ring 50 at its forward end. As illustrated in FIGS. 2A and 2B, the excavator boom or stick 30 and the excavator's hydraulic cylinder 36 are pivotally attached to the boom mount 24 by a boom pin 32 and a cylinder pin 38, permitting the material handling attachment 10 to pivoted about the axis of the boom pin 32 as indicated by arrow 42 (FIG. 1), when the hydraulic cylinder 36 is extended and retracted.

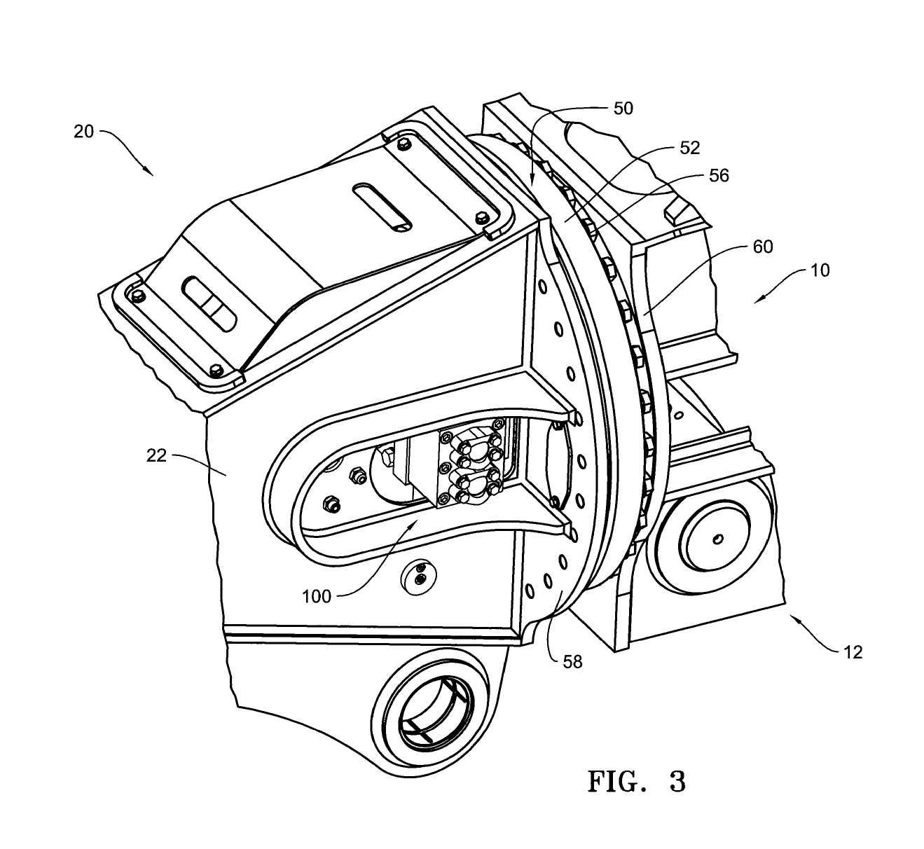

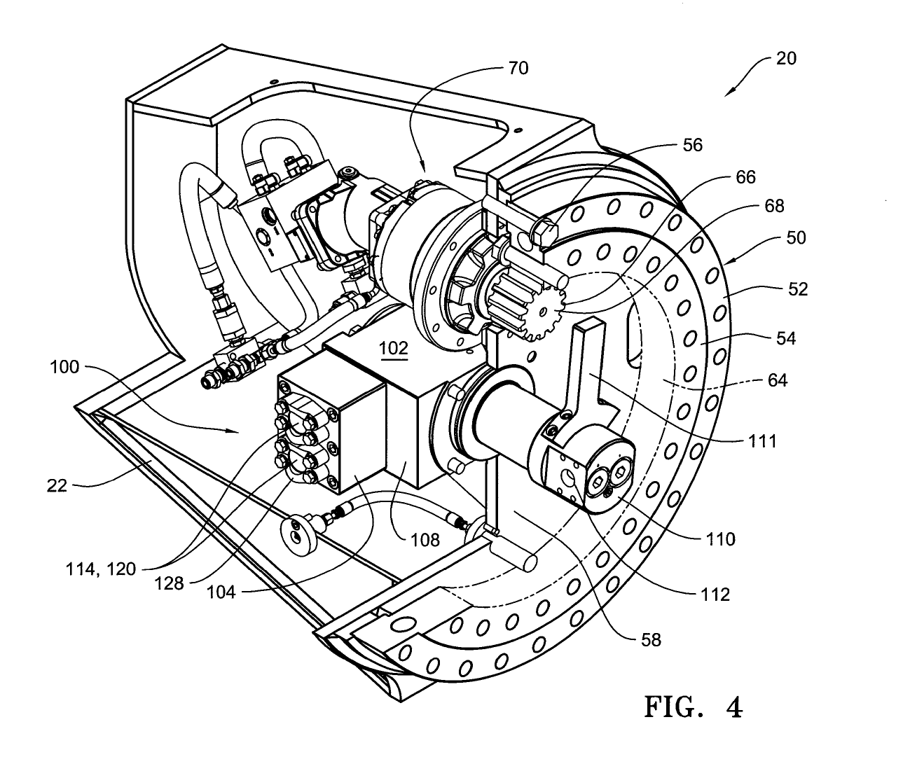

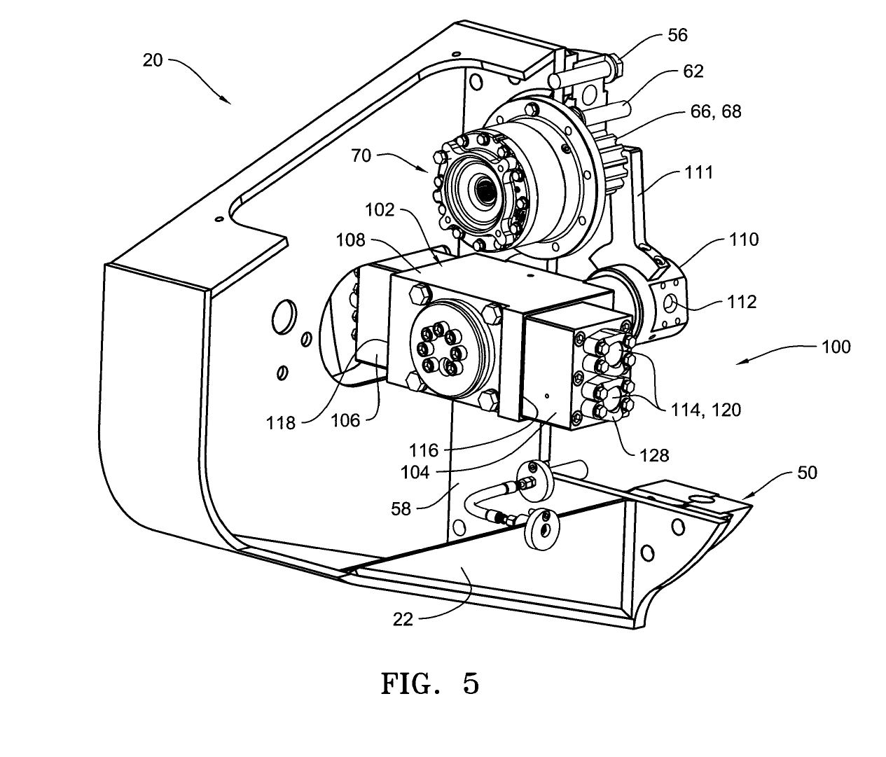

FIGS. 3-5 illustrate an embodiment of a typical swivel attachment 20 and slewing ring 50. The slewing ring 50 includes a stationary outer race 52 and an inner race 54 which is rotatable within the stationary outer race 52. The stationary outer race 52 is secured by threaded connectors 56 to a bulkhead 58 at the forward end of the swivel house 22. The inner race 54 is secured to a mounting plate 60 (FIG. 3) at the rear end of the main body 12 of the material handling attachment by threaded connectors 62 (FIG. 5). The inner race 54 has internal gear teeth 64 (designated by the phantom line in FIG. 4). The internal gear teeth 64 of the inner race 54 are engaged by external gear teeth 66 of the gear 68 projecting through the bulkhead 58. The gear 68 is rotated by the hydraulic gear drive 70 secured within the swivel house 22. Thus, it should be appreciated that as the hydraulic gear drive 70 rotates the gear 68, the external gear teeth 66 engage the internal gear teeth 64 of the inner race 54 causing the main body 12 of the material handling attachment to rotate or swivel about the central axis of the slewing ring 50 as indicated by arrow 72 in FIG. 1.

FIGS. 4-6 illustrate an embodiment of an improved hydraulic swivel assembly 100 which includes a hydraulic swivel 102 and a pair of manifold blocks 104, 106. The hydraulic swivel 102 includes a base 108 and a rotatable extension 110. The base 108 mounts to the forward bulkhead 58 of the swivel house and thus remains stationary. The rotatable extension 110 projects through the bulkhead 58 and is rotatable with the main body 12 of the material handling attachment 10. A post 111 extends from the rotatable extension and is loosely received by a U-shaped bracket (not shown) at the rearward end 16 of the main body 12 of the material handling attachment 10 to ensure that the rotatable extension 110 rotates with the main body 12.

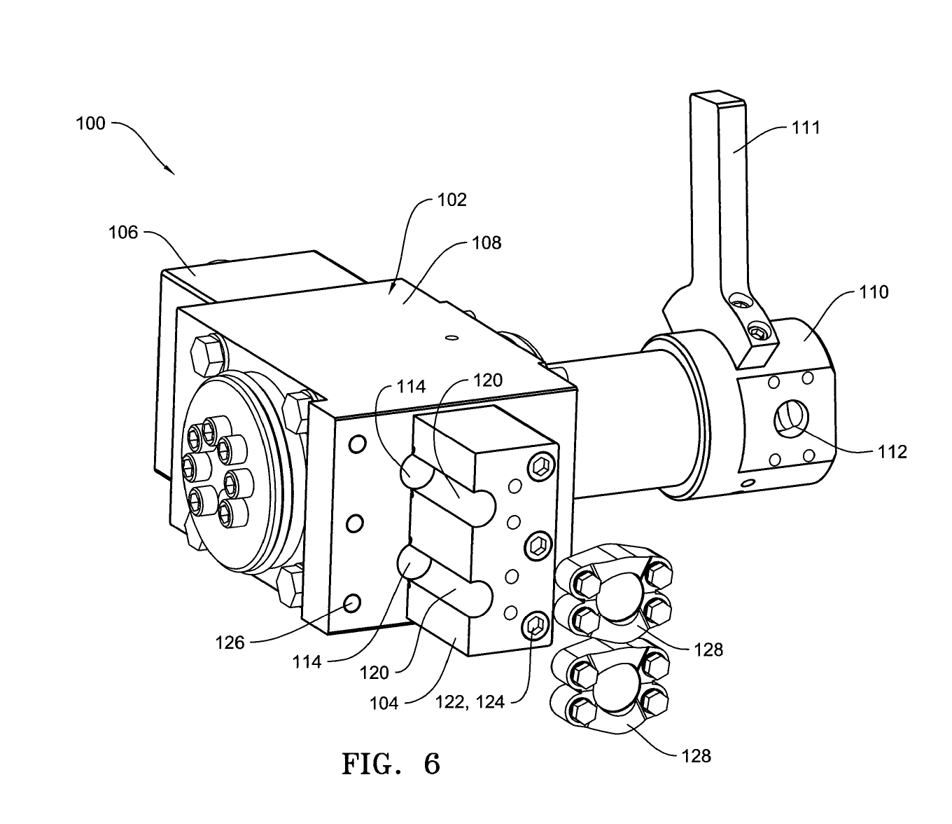

Hydraulic lines (not shown) of the material handing attachment 10 are coupled to the ports 112 of the rotatable extension 110 of the hydraulic swivel 102. The stationary base 108 of the hydraulic swivel 102 includes multiple ports 114 (preferably at least two, or more if needed) (FIG. 6) on the sides 116, 118 of the base 108.

As best viewed in FIG. 6, the manifold blocks 104, 106 are made of material suitable for the hydraulic pressures of the excavator's hydraulic system and include ports 120 which mateably align with the ports 114 of the base 108. The manifold blocks 104, 106 are attached to the base 108 by threaded connectors 122 which extend through holes 124 in the manifold blocks 104, 106 and are threadably received by tapped holes 126 in the base 108. A gasket (not shown) may be disposed between the mating faces of the manifold blocks 104, 106 and the base 108. The hydraulic lines (not shown) of the excavator are coupled to the ports 120 of the manifold blocks 104, 106 using conventional split-flanges 128 which are secured to the manifold blocks by threaded connectors.

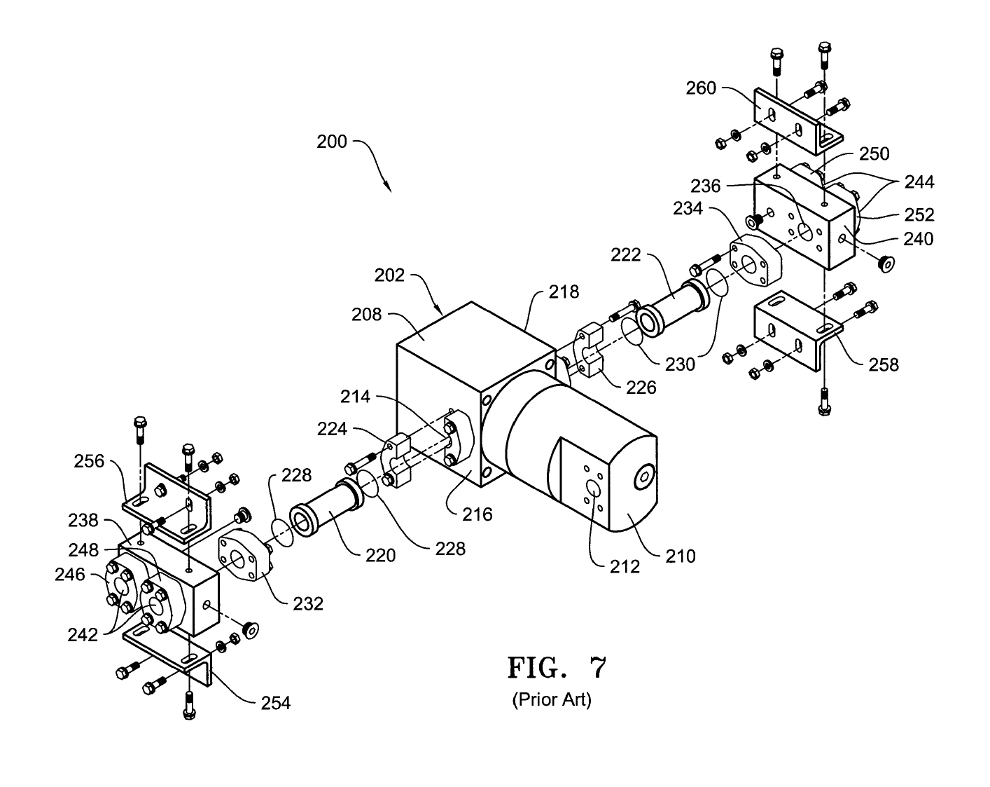

In comparison to the embodiment of the improved hydraulic swivel assembly 100, a typical prior hydraulic swivel assembly 200 is shown in FIG. 7 as an exploded perspective view to illustrate the multiple components needed for the prior art hydraulic swivel assembly 200. The prior art hydraulic swivel assembly 200 includes a hydraulic swivel 202 with a base 208 and a rotatable extension 210. The base 208 is mounted to the forward bulkhead (not shown) of the swivel house as previously described and thus remains stationary. The rotatable extension 210 extends through the bulkhead as previously described and is rotatable with the main body 12 of the material handling attachment 10. As previously described in connection with the improved hydraulic swivel assembly 100, a post (not shown) is attached to the rotatable extension and is loosely received by a U-shaped bracket (not shown) at the rearward end 16 of the main body 12 of the material handling attachment 10 to ensure that the rotatable extension 110 rotates with the main body 12.

Port tubes 220, 222 couple to single ports 214 on the sides 216, 218 of the hydraulic swivel 202 by a split flanges 224, 226 secured by threaded connectors to the stationary base 208. Gaskets 228, 230 are provided at each end of the port tubes 220, 222. The outer ends of each of the port tubes 220, 222 are coupled by a split flanges 232, 234 over single inner ports 236 on inner sides of respective port blocks 238, 240. The outer sides of the port blocks 238, 240 include two outer ports 242, 244 for coupling the hydraulic lines (not shown) of the excavator using split flanges 246, 248, 250, 252 secured by threaded connectors. It should be appreciated that the port blocks 238, 240 include internal passages which connect the two outer ports 242, 244 to the single inner ports 236. Two pairs of support brackets 254, 256, 258, 260 attach to the respective port blocks 238, 240 for supporting and securing the port blocks 238, 240 to the swivel house (not shown).

It should be appreciated that unlike the prior art hydraulic swivel assembly 200, the embodiment of the improved hydraulic swivel assembly 100 does not require separate mounting or support brackets as part of the assembly because the manifold blocks 104, 106 are directly mounted to and supported by the base 108 of the hydraulic swivel 102 which is rigidly mounted to the bulkhead 58.

It should also be appreciated that the improved hydraulic swivel assembly 100 has only seven components; namely the hydraulic swivel 102, the two manifold blocks 104, 106 and the four split flanges 128. The prior art hydraulic swivel assembly 200, on the other hand, has no less than 17 components, not including the threaded connectors and gaskets; namely, the hydraulic swivel 202, the split flanges 224, 226 attached to the base 208, the port tubes 220, 222, the split flanges 232, 234 connecting the port tubes 220, 222 to the inner ports 236, the two port blocks 238, 240, the four slit flanges 246, 248, 250, 252 connecting the excavator lines to the two outer ports 242, 244 on the outside of the port blocks 238, 240, and the two pairs of support brackets 254, 256, 258, 260. The prior art hydraulic swivel assembly 200 also requires 48 threaded connectors to attach the various components to one another and to mount the support brackets to the swivel house whereas the improved hydraulic swivel assembly 100 requires only 28 threaded connectors.

It should also be appreciated that the improved hydraulic swivel assembly 100 has only six potential leak points (three on each side of the hydraulic swivel 102); namely, the interface of the two hydraulic lines from the excavator to the outer sides of the manifold blocks 104, 106 at the split flanges 128 and the interface of the manifold blocks 104, 106 to the base 108 of the hydraulic swivel 102. The prior art hydraulic swivel assembly 200, on the other hand, has eight potential leak points (four on each side of the hydraulic swivel 202); namely, the interface of the two hydraulic lines from the excavator to the two outer ports 242, 244 at the split flanges 246, 248, 250, 252, the interface of the port tubes 220, 222 over the single inner ports 236 at the split flanges 232, 234, and the interface of the port tubes 220, 222 over the single ports 214 on the sides of the hydraulic swivel 202 at the split flanges 224, 226.

Accordingly, the improved hydraulic swivel assembly 100 has less than half the parts and substantially fewer potential leak points compared to the prior art hydraulic swivel assembly 200 and requires twenty fewer threaded connectors to install, thereby resulting in substantial labor savings in installation as well as substantial labor savings in maintenance and repair costs.

It should also be appreciated that although the improved hydraulic swivel assembly 100 is described as being particularly adapted to a swivel attachment for a material handling attachment mounted to an excavator, the improved hydraulic swivel assembly 100 is equally suitable for any application which utilizes a hydraulic swivel for communicating hydraulic fluid from a non-rotatable member to a rotatable member.

The foregoing description is presented to enable one of ordinary skill in the art to make and use the invention and is provided in the context of a patent application and its requirements. Various modifications to the embodiments described herein, and the general principles and features of the embodiments described herein will be readily apparent to those of skill in the art. Thus, the present invention is not to be limited to the embodiments described herein and illustrated in the drawing figures, but is to be accorded the widest scope consistent with the spirit and scope of the appended claims.

1. A hydraulic swivel assembly, comprising:
a hydraulic swivel having a plurality of ports on a base and a plurality of ports on a rotatable extension;
a manifold block secured to said base, said manifold block having a corresponding plurality of ports matingly aligning with said plurality of ports of said base;
whereby said plurality of ports on said manifold block are adapted to couple to a first set of hydraulic lines of a non-rotatable member and said plurality of ports on said rotatable extension are adapted to couple to a second set of hydraulic lines of a rotatable member.

2. The hydraulic swivel assembly of claim 1 wherein said hydraulic swivel includes a plurality of ports on a plurality of sides of said base and a plurality of manifold blocks respectively secured to said plurality of sides of said base, each of said plurality of manifold blocks having a corresponding plurality of ports matingly aligning with said plurality of ports of said base.

3. A swivel attachment, comprising:
a swivel house adapted to be attached to a non-rotatable member;
a slewing ring having an outer race which rigidly attaches to said swivel house and an inner race which rigidly attaches to a rotatable attachment, said inner race rotatable with respect to said outer race;
a hydraulic swivel assembly comprising:
a hydraulic swivel having a plurality of ports on a base and a plurality of ports on a rotatable extension;
a manifold block secured to said base, said manifold block having a corresponding plurality of ports matingly aligning with said plurality of ports of said base;
whereby said plurality of ports on said manifold block are adapted to couple to a first set of hydraulic lines of said non-rotatable member and said plurality of ports on said rotatable extension are adapted to couple to a second set of hydraulic lines of a rotatable member.

4. The swivel attachment of claim 3 wherein said hydraulic swivel includes a plurality of ports on a plurality of sides of said base and a plurality of manifold blocks respectively secured to said plurality of sides of said base, each of said plurality of manifold blocks having a corresponding plurality of ports matingly aligning with said plurality of ports of said base.

5. A material handling attachment adapted to be mountable to a boom of an excavator, comprising:
a rotatable main body having a forward end and a rearward end;
a swivel attachment, comprising:
a swivel house adapted to be attached to an excavator boom;
a slewing ring having an outer race which rigidly attaches to said swivel house and an inner race which rigidly attaches to said rearward end of said rotatable main body, said inner race rotatable with respect to said outer race;
a hydraulic swivel assembly comprising:
a hydraulic swivel having a plurality of ports on a base and a plurality of ports on a rotatable extension;
a manifold block secured to said base, said manifold block having a corresponding plurality of ports matingly aligning with said plurality of ports of said base;
whereby said plurality of ports on said manifold block are adapted to couple to a first set of hydraulic lines from the excavator and said plurality of ports on said rotatable extension are adapted to couple to a second set of hydraulic lines which rotate with said rotatable main body.

6. The material handling attachment of claim 5 wherein said hydraulic swivel includes a plurality of ports on a plurality of sides of said base and a plurality of manifold blocks respectively secured to said plurality of sides of base, each of said plurality of manifold blocks having a corresponding plurality of ports matingly aligning with said plurality of ports of said base.
